(19) United States
(12) Patent Application Publication
(10) Pub. No.: US 2026/0203052 A1
(43) Pub. Date: Jul. 16, 2026

(54) GENERATIVE ARTIFICIAL INTELLIGENCE AGENT ASSISTED SOFTWARE DEVELOPMENT

(71) Applicant: Wells Fargo Bank, N.A., San Francisco, CA (US)

(72) Inventors: Austin Lee Grelle, Riverside, IL (US); Juan Pabo Gutierrez, Whittier, CA (US); Manesh Saini, New York, NY (US); Winthrop Treynor Smith, Littleton, CO (US); Laura Kaye Woten, Stuart, IA (US)

(21) Appl. No.: 19/020,968

(22) Filed: Jan. 14, 2025

(51) Int. Cl. G06F 8/71; G06F 8/35; G06F 11/3668

(52) U.S. Cl. CPC G06F 8/71; G06F 8/35; G06F 11/3688

(57) ABSTRACT

A method may include inputting a data file associated with an application into a generative artificial intelligence agent (genAI agent); in response to the inputting, executing the genAI agent, wherein executing the genAI agent includes: identifying a problem with the application; determining a user identifier for addressing the potential problem; determining a solution to the problem; generating an action data structure; and based on the action data structure, issuing an application programming interface (API) call to an issue tracking system to create a new issue ticket, the API call identifying the problem, the solution, and the user identifier; receiving feedback from the user identifier, the feedback rating the solution; and updating the genAI agent based on the feedback.

### BACKGROUND

Issue tracking systems are database applications that manage tasks and bugs throughout their lifecycle in software development. These systems implement may use state machines to track issues through stages like “New” to “Resolved,” while capturing metadata such as priority and assignees. Some integrate with development tools and expose APIs providing a centralized record of project status and history.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a system architecture diagram, according to various examples.

FIG. 2 is a flowchart illustrating generative artificial agent operations, according to various examples.

FIG. 3 is an example user interface for interacting with a GenAI agent and an issue-tracking system, according to various examples.

FIG. 4 is a flowchart illustrating a method to execute a genAI agent, according to various examples.

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

In the realm of software development, issue tracking systems play a role in managing tasks and bugs throughout their lifecycle. These systems are designed to capture, prioritize, and resolve issues. The process of identifying and addressing issues often involves a significant delay, primarily due to the reliance on manual reporting and intervention. This delay can lead to prolonged development cycles, increased costs, and a higher likelihood of unresolved issues impacting the final product.

Existing issue tracking systems, while effective in maintaining a record of project status and history, exhibit several shortcomings. One disadvantage is the slow feedback loop in these systems. Users manually report issues, which are then logged and assigned to developers. This process can be time-consuming and prone to human error. Additionally, the manual nature of these systems often leads to inconsistent prioritization and tracking of issues, further complicating the development process. Integration with development tools, while available, is often limited and does not fully automate the workflow, leaving gaps that require manual intervention.

The disclosed systems and methods use generative artificial agents (genAI agents) to improve issue tracking and resolution in software development. For example, one agent may serve as a virtual assistant, capable of interacting with users in real-time, providing support on existing issue tickets. Another agent may integrate with development tools for automating ticket creation and management, categorize issues based on severity, and track the status of tickets. Furthermore, the agents may continuously learn from user interactions and system performance, applying machine learning techniques to improve the agent's diagnostic and problem-solving capabilities over time.

The solution provided by the autonomous generative artificial intelligence (GenAI) agent goes beyond simply automating a manual process in several ways. Firstly, unlike traditional systems that rely on users to manually report issues, a GenAI agent may proactively monitor system performance and error logs to identify potential issues before they are reported. This proactive approach helps in catching problems early, reducing the time and effort required for resolution.

Secondly, the GenAI agent uses machine learning techniques to categorize issues based on severity, type, and potential impact. This intelligent prioritization ensures that issues are addressed promptly, optimizing the development team's workload and improving overall efficiency. Another advantage is the agent's ability to continuously learn from past incidents, user interactions, and system performance data. This continuous learning capability allows the agent to improve its diagnostic and problem-solving abilities over time, making it more effective in identifying and resolving issues.

The GenAI agent may also engage with users to gather feedback on the effectiveness of deployed solutions. This feedback loop helps in refining the agent's responses. The agent may also provide updates to users on the status of their reported issues, ensuring transparency and keeping users informed.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

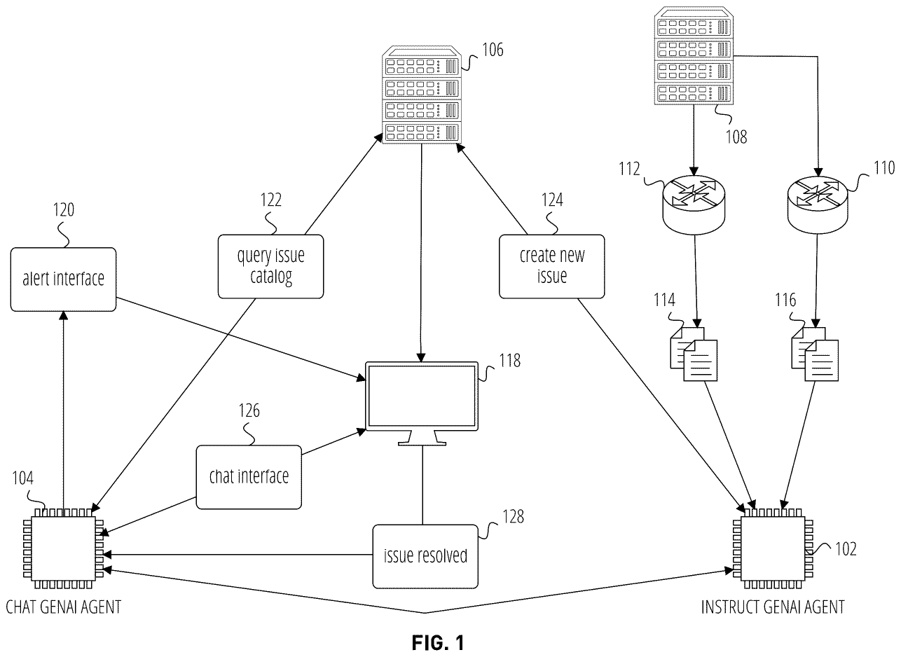

FIG. 1 is a system architecture diagram, according to various examples. Although a particular arrangement and number of elements are shown, other arrangements may be used without departing from the scope of this disclosure. For example, logs 112 and production databases 110 may be a single database or split into several more databases.

The backend processes 108 may represent the various systems, databases, applications, software development tools, issue-tracking systems, and network devices an organization uses. For example, one backend process may be responsible for user authentication while another manages a network firewall. As part of their operations, the backend processes 108 may generate diagnostic data (e.g., logs 112) and production data (e.g., production databases 110).

Application log files may contain detailed information about application behavior, errors, exceptions, and user interactions. The logs may include timestamps, severity levels, and stack traces that help developers and system administrators diagnose problems and track application flow. Database systems may produce several output files for monitoring and troubleshooting, such as transaction logs, audit trails, and database error logs identifying document failed operations. System performance metrics files may include data about resource utilization, including CPU usage, memory consumption, disk I/O, and network traffic. Network devices and security systems may generate their own set of output files. These include access logs showing connection attempts and authentication events, firewall logs, etc.

Software development may generate various types of logs. For example, build logs capture compilation results, showing compiler warnings, errors, and dependency issues that help developers identify problems early. Version control systems may create commit logs tracking code changes, and pipeline logs may record the automated deployment process from code checkout to deployment. Package managers create logs during dependency installation, showing version conflicts and compatibility issues.

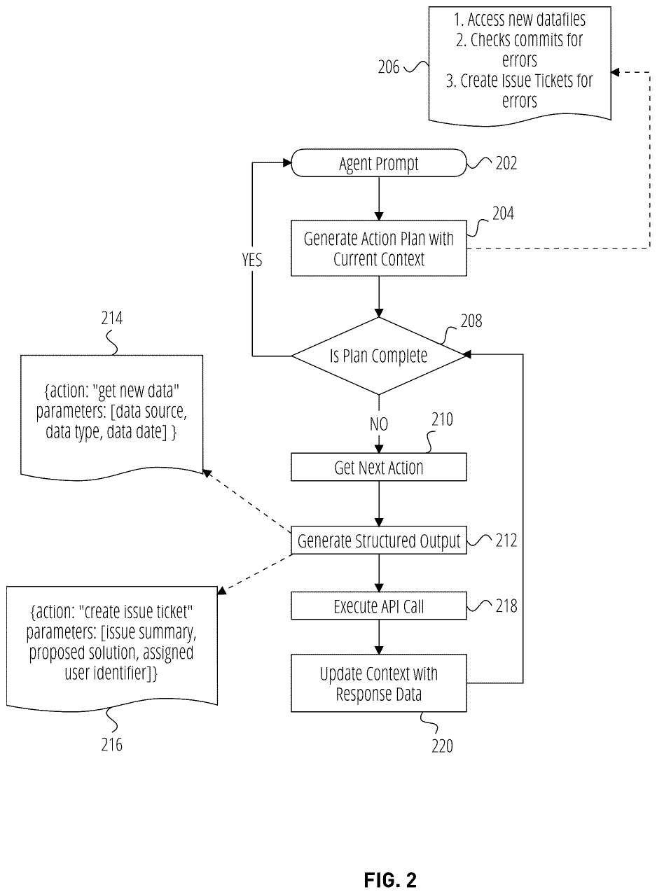

Datafile 114 and datafile 116 represent data that may be pushed or pulled to instruct GenAI agent 102 for processing from logs 112 and production databases 110, respectively. A data file may be a portion of the data stored in logs 112 or production databases 110. For example, datafile 114 may be a commit log from the version control system, and datafile 116 may be a web server's latest hour of performance metrics. An example of how the instruct GenAI agent 102 may process datafiles to identify potential issues and generate issue tickets (e.g., new ticket command 124) is discussed in FIG. 2.

The issue management system 106 may serve as a centralized platform for managing the lifecycle of software projects and their associated tasks, bugs, and feature requests. The issue management system 106 may track, prioritize, and resolve various items throughout the software development process. For example, the system may include structured ways to create, assign, and monitor work items, typically referred to as “tickets” or “issues” (referred to as issue tickets herein).

An issue ticket within the issue management system 106 may contain information such as a unique identifier, title, description, priority level, current status, and assigned users. The status of an issue ticket generally progresses through predefined stages such as “New,” “In Progress,” “Under Review,” and “Completed.” The system may also maintain a history of all changes and communications related to each ticket, creating an audit trail that helps users understand how issues were resolved, and decisions were made.

The issue management system 106 may also integrate (e.g., via an application programming interface (API)) with version control systems and continuous integration/continuous deployment (CI/CD) pipelines, enabling users to link specific code changes to their corresponding issue tickets.

The computing device 118 may be but is not limited to, a smartphone, tablet, laptop, multi-processor system, microprocessor-based or programmable consumer electronics, game console, set-top box, or another device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

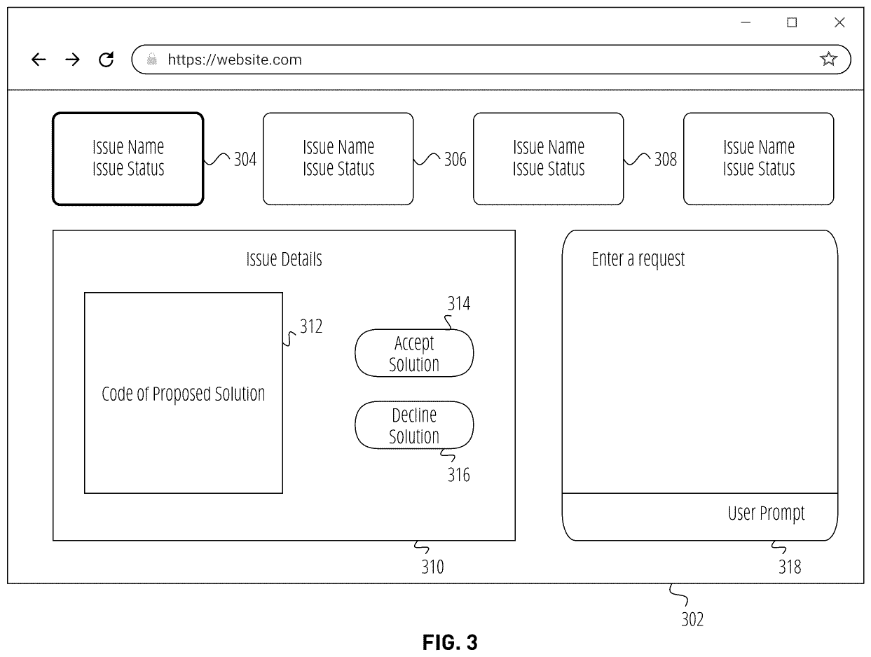

The computing device 118 may interface with the issue management system 106 to view issue tickets through a web browser or a dedicated application. Once logged into the issue management system 106, users may navigate to a listing of open issues, where each ticket contains details such as issue description, status, assigned team, and due dates. An example interface is discussed in FIG. 3.

The computing device 118 may use chat interface 126 to communicate with the chat GenAI agent 104. In various examples, the chat interface 126 may be part of the interface provided by the issue management system 106. Users may compose a query or request information and send it to the GenAI agent 104 via chat GenAI agent 104. The chat GenAI agent 104 may process the query and provide a response, which can be read within the same interface or sent to another communication channel.

For example, a user may enter “Please provide a status update for issue XYZ” to the chat GenAI agent 104. They chat GenAI agent 104 may use its transformer architecture to encode the input text into a high-dimensional representation. The self-attention mechanisms within the transformer analyze the relationships between all words in the query, creating attention maps that highlight elements such as “status update” and “XYZ.” The positional encodings ensure the model maintains awareness of word order and query structure.

The transformer's decoder then processes this encoded representation through multiple layers containing self-attention and cross-attention mechanisms. These mechanisms help the model focus on relevant parts of both the input query and its internal knowledge about API interactions. The model's learned weights and biases, distributed across numerous attention heads, help identify the intent and required actions from the encoded representation.

The chat GenAI agent 104 may use its pre-trained understanding of API interactions with the issue management system 106, which is embedded in the weights of its neural network layers. These embeddings allow the chat GenAI agent 104 to map the natural language request to specific API requirements. The transformer's feed-forward neural networks in each layer process the attention outputs to convert abstract semantic representations into concrete API parameters.

When preparing the API request, the chat GenAI agent 104 may use its context window to maintain awareness of any relevant previous conversation history or authentication context. Different attention heads in the architecture of chat GenAI agent 104 may specialize in different aspects of the request, such as endpoint selection, parameter formatting, or authentication requirement identification. The chat GenAI agent 104 may issue the API call (e.g., query command 122) to issue management system 106.

Upon receiving the API response from the issue management system 106, the transformer processes the structured data through its encoder layers again, creating a new semantic representation. The decoder then generates a natural language response where each output token is influenced by both the encoded API response and the previously generated response tokens. Finally, the response may be presented to the user.

A user may make other requests or issue commands to the chat GenAI agent 104 to interact with the issue management system 106. For example, a user may tell the chat GenAI agent 104 that an issue ticket has been resolved (e.g., issue resolved message 128). The chat GenAI agent 104 may perform a similar encoding and decoding process to issue an API call to issue management system 106 to indicate the identified issue has been resolved.

The chat GenAI agent 104 may communicate with other GenAI agents, such as instruct GenAI agent 102. For example, the instruct GenAI agent 102 may transmit a message to chat GenAI agent 104 that an alert has been issued to a user to resolve a high-priority issue identified by the instruct GenAI agent 102. The chat GenAI agent 104 may then alert the user via alert interface 120, which may be part of the interface presented by the issue management system 106.

Although not depicted in FIG. 1, the operations described herein may be executed on a processing system. For example, computer program code may be stored on a storage device and loaded into the processing system's memory for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Furthermore, the data used by the operations may be stored in a data store. A data store may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. A data store may store data on one or more storage devices (e.g., a hard disk, random access memory (RAM), etc.). The storage devices may be in standalone arrays, part of one or more servers, and located in one or more geographic areas.

FIG. 2 is a flowchart illustrating generative artificial agent operations according to various examples. The operations of FIG. 2 may be performed by a large language model (LLM) generative artificial intelligence agent (genAI agent) such as instruct GenAI agent 102 of FIG. 1. In various examples, instruct GenAI agent 102 may be multi-modal (e.g., capable of processing image, audio, and text). For discussion purposes, the operations of FIG. 2 are described in the context of (and using the components of) a system architecture as depicted in FIG. 1. However, the operations of FIG. 2 may be performed with other system architectures.

The agent prompt 202 serves as the initial input for the genAI agent. In contrast to a chat-focused agent (e.g., chat GenAI agent 104), instruct GenAI agent 102 may operate using automatic prompts or as part of a more extensive software application that does not require explicit user input.

For example, the agent prompt 202 may be a stored prompt executed periodically (e.g., hourly) or in response to a trigger (e.g., a new log file, API call, webhook, etc.). The prompt may be “Detect conflicts in dependencies” or “Identify abnormal application performance and suggest a code fix.”

The agent prompt 202 may serve as the initial context for the instruct GenAI agent 102. Context in an LLM refers to the sequence of tokens that precede the current position where the model generates its next output. This context window represents the model's working memory and determines what information is available for processing during inference. The context consists of the input prompt and any previously generated tokens up to a fixed maximum length defined by the model's architecture.

Using agent prompt 202, operation 204 may be performed, and an action plan may be generated. An action plan may be a text output from an LLM to accomplish the task identified in the agent prompt 202. For example, action plan output 206 includes three steps: 1. Access new datafiles; 2. Checks commit logs for errors; and 3. Create Issue Tickets for errors.

The action plan may become part of the instruct GenAI agent 102 context. Then, the instruct GenAI agent 102 may determine at decision block 208 if all the action plan steps have been completed. The determination may be made by the instruct GenAI agent 102 by executing a prompt that checks the context to see if there are still outstanding actions from the action plan. If there are not, the operational flow may continue back to agent prompt 202 for the next prompt.

At operation 210, the next unperformed action from the action plan may be performed. The first part of the performance may be at operation 212, in which the instruct GenAI agent 102 determines a structured output for the next action. The structured output for an action may output from the instruct GenAI agent 102 based on its trained weights (discussed below). For example, an action for obtaining new data files may output a structure such as structured action output 214, and an action for creating an issue ticket may output structured action output 216. As illustrated, the structure output may include an action identifier and parameters related to that action.

At operation 218, an API call may be transmitted based on the structured action output. For example, the instruct GenAI agent 102 may include a software routine that accepts the structured action output as input. The software routine may correlate the action to an API endpoint and create the API call that is transmitted. The API call results (e.g., a JavaScript object notation data payload) may be added to the context (e.g., operation 220) of the instruct GenAI agent 102 for processing. Then, the operational flow returns to decision block 208 to determine if the action plan is complete.

The instruct GenAI agent 102 may be trained on the API formats with which the systems may interact. For example, a training input may be: {“context”: generate new issue ticket”, “API call” {“endpoint”: “/API/issues”, “method”: “POST”, “parameters”: {“name”: “Issue with application”, “issue summary”: “slow loading on website”, “assigned_user”: “john@example.com”, “potential_solution”: “update python version”}}}. Furthermore, training inputs may include an input prompt, an action plan, and the structured action output for each of the actions in the action plan.

The weights of the instruct GenAI agent 102 may be updated using the training examples using a cost function. For example, reinforcement learning may define various scores for the agent's success. A successful API call may be given a score of two, whereas a failed API call may be a negative one. As the instruct GenAI agent 102 processes more training data, the instruct GenAI agent 102 may learn to maximize successful API calls and minimize failed ones. These scores are simple examples, and others may be used.

Other structured training data sets may be used for the different prompts that may be used with instruct GenAI agent 102. For example, there may be a training data set for suggesting code to fix a problem based on past code fixes. There may be a training data set that defines an action plan for determining a potential user to assign an issue ticket. There may be a training data set for issuing alerts (e.g., push notifications or emails) to a user to address a new ticket. The training data sets may be based on historical data used by the issue management system 106 and datafiles from backend processes 108.

FIG. 3 is an example user interface for interacting with a GenAI agent and an issue-tracking system, according to various examples.

FIG. 3 includes a user interface 302, which combines access to a chat GenAI agent (e.g., chat GenAI agent 104) and an issue management system (e.g., the issue management system 106). The user interface 302 may be presented in response to a user logging in with their credentials to the issue management system with a computing device (e.g., computing device 118).

The user interface 302 includes a section displaying multiple issue tickets. Each issue ticket, such as issue 306 and issue 308, contains information, including the issue name and current status. Upon selecting an issue such as selected issue 304, the detailed issue view 310 may be updated. Detailed issue view 310 shows more in-depth information about the selected issue 304. This includes solution details 312, which may contain the code or proposed solution to the issue. The detailed issue view 310 also includes interactive elements such as the accept element 314 and the decline element 316, enabling users to accept or decline the proposed solution.

The accept element 314 and the decline element 316 may be used to update the weights of an instruct genAI agent (e.g., instruct GenAI agent 102). When a user accepts the proposed solution by interacting with the accept element 314, positive feedback is sent to the instruct genAI agent. This feedback may reinforce the agent's decision-making process, thereby updating its weights to favor similar solutions in the future. Conversely, negative feedback is sent to the agent when a user declines the proposed solution by interacting with the decline element 316. This feedback helps the agent learn from its mistakes, adjusting its weights to avoid suggesting similar solutions in the future.

The user interface 302 also features a chat agent interface 318. The chat agent interface 318 allows users to enter a request or query, which the chat GenAI agent processes. The chat GenAI agent can issue commands to the issue management system based on the user's input, facilitating efficient issue resolution and management. For example, a user prompt may be “Please accept the solution and close the selected issue ticket.” The chat GenAI agent may then process the input and transmit an API call to the issue management system to close the selected issue ticket.

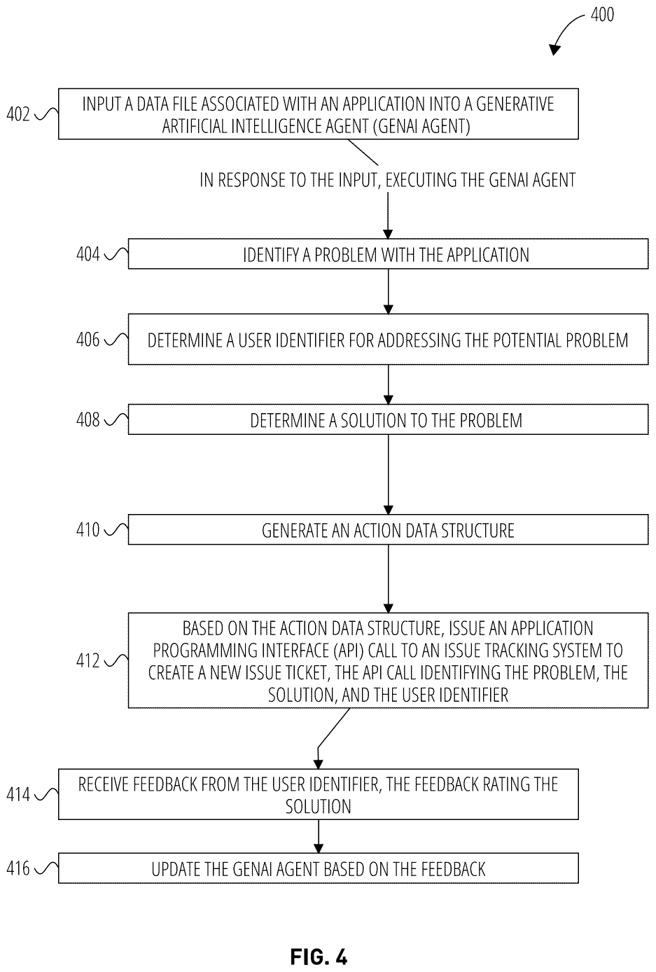

FIG. 4 is a flowchart illustrating method 400 to execute a genAI agent, according to various examples. The method is represented as a set of blocks that describe operations. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executes the set of instructions, may configure the processing unit to perform the operations illustrated in FIG. 4. The processing unit may instruct another component of a computing device to carry out the set of instructions. For example, the processing unit may instruct a network device to transmit data to another computing device or the computing device may provide data over a display interface to present a user interface. In some examples, the performance of the method may be split across multiple computing devices using a shared computing infrastructure (e.g., the processing unit encompasses multiple distributed computing devices).

In block 402, method 400 inputs a data file associated with an application into a generative artificial intelligence agent (genAI agent). For example, the data file may be obtained from backend processes such as application log files containing detailed information about application behavior, errors, exceptions, and user interactions, or from software development processes like build logs showing compiler warnings and errors. The data file may be pushed or pulled from logs or production databases, such as a commit log from a version control system or the latest hour of performance metrics from a web server. This operation may be triggered periodically or in response to specific events, with the genAI agent (e.g., instruct GenAI agent 102) processing the input as part of its operational flow. The data file serves as initial input for the genAI agent's context window, which represents the model's working memory and determines what information is available for processing during inference.

In various examples, the data file represents a merge request for code of the application, which may be processed through the version control systems integrated with the issue management system 106 via API connections. The version control systems generate commit logs tracking code changes that can be processed by the instruct GenAI agent 102.

In response to the input, method 400 executes the genAI agent through a series of operations. The execution leverages the transformer architecture's self-attention mechanisms and positional encodings to analyze relationships between elements in the input data, similar to how chat GenAI agent 104 processes queries. The agent's neural network layers, distributed across numerous attention heads, help identify required actions from the encoded representation. For example, the genAI agent may be executed and trained in the manner described for FIG. 2.

In block 404, method 400 identifies a problem with the application. The identification process may include analyzing diagnostic data from backend processes 108, including application log files containing detailed information about application behavior, errors, exceptions, and user interactions. The instruct GenAI agent 102 man process this information through its pre-trained understanding embedded in the weights of its neural network layers.

In various examples, the problem is a conflict with another application. The conflict may be detected through analysis of package manager logs showing dependency conflicts and version compatibility issues generated by backend processes 108. The instruct GenAI agent 102 may use its training on API formats and historical data to identify these conflicts.

In block 406, method 400 determines a user identifier for addressing the potential problem. This determination may be me using the issue management system 106's structured data about assigned users and teams. The instruct GenAI agent 102 may use specific training data sets that define an action plan for determining potential users to assign issue tickets, based on historical data from the issue management system 106.

In block 408, method 400 determines a solution to the problem such as suggesting a code change to the application or delaying an update to another application. The solution determination process utilizes the instruct GenAI agent's training on historical data from issue management system 106 and datafiles from backend processes 108. The agent processes this through its transformer layers, where different attention heads may specialize in different aspects like endpoint selection and parameter formatting. The solution may be presented through the detailed issue view 310 of user interface 302, which displays solution details 312 containing the proposed fix. For example, the solution to the problem may be suggesting a code change to the application.

In block 410, method 400 generates an action data structure. The action data structure is generated by the instruct GenAI agent 102 based on its trained weights and understanding of API interactions. This structure may be similar to the structured action outputs illustrated in structured action output 214 and 216, which include action identifiers and related parameters

In various examples, generating the action data structure includes generating a structured output that includes a create new issue action identifier, the user identifier, the solution, and the problem. This structured output format aligns with the training inputs provided to the instruct GenAI agent 102, such as the example training input that includes endpoint, method, and parameters for creating new issue tickets. The structured output is processed through the transformer's decoder layers, which use self-attention and cross-attention mechanisms to format the appropriate API parameters.

In various examples, executing the genAI agent may further include assigning a severity level to the problem. This severity assessment may be based on the diagnostic data from backend processes 108, which includes information about application behavior, errors, and system performance metrics.

In block 412, method 400 based on the action data structure, issues an application programming interface (API) call to an issue tracking system to create a new issue ticket, the API call identifying the problem, the solution, and the user identifier. This operation may use the instruct GenAI agent's pre-trained understanding of API interactions with the issue management system 106. The API call creates a new issue ticket containing information such as a unique identifier, title, description, priority level, current status, and assigned users within the issue management system 106. The created ticket may then be accessed through user interface 302, where the detailed issue view 310 displays the ticket information including solution details 312.

In various examples, executing the genAI agent may further include transmitting an alert to the user identifier. This alert functionality may be implemented through the chat GenAI agent 104's ability to communicate alerts via alert interface 120, which may be integrated within the interface presented by the issue management system 106. The chat GenAI agent 104 may receive messages from other agents like instruct GenAI agent 102 to issue alerts about high-priority issue to computer devices associated with an assigned or responsible user.

In various examples, executing the genAI agent may further include, initiating automated testing for the application as a potential solution. For example, the testing may generate diagnostic data and logs that may be analyzed by the genAI agent for identifying potential issues.

In block 414, method 400 receives feedback from the user identifier, the feedback rating the solution. This feedback may be provided through user interface elements like accept element 314 and decline element 316 in the detailed issue view 310. When users interact with these elements to either accept or decline a proposed solution, the feedback is sent to the instruct GenAI agent.

In block 416, method 400 updates the genAI agent based on the feedback. The updating process may use reinforcement learning with defined scores for successful and unsuccessful outcomes. For example, when a user accepts the proposed solution through the accept element 314, positive feedback is sent to the instruct GenAI agent, reinforcing its decision-making process and updating its weights to favor similar solutions in the future. Conversely, when a user declines a solution through decline element 316, negative feedback helps the agent learn from mistakes by adjusting its weights to avoid suggesting similar solutions.

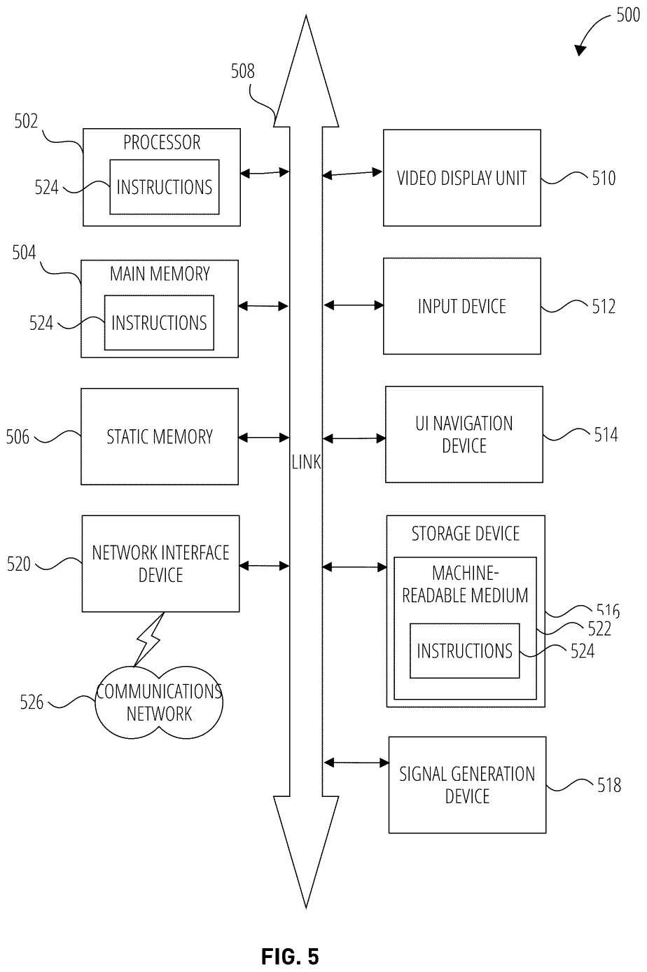

FIG. 5 is a block diagram illustrating a machine in the example form of computer system 500, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 500 includes at least one processor 502 (e.g., a central processing unit (CPU), a graphics processing unit (GPU) or both, processor cores, compute nodes, etc.), a main memory 504, and a static memory 506, which communicate with each other via a link 508. The computer system 500 may include a video display unit 510, an input device 512 (e.g., a keyboard), and a user interface UI navigation device 514 (e.g., a mouse). In an example, the video display unit 510, input device 512, and UI navigation device 514 are incorporated into a single device housing, such as a touchscreen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which one or more sets of data structures and instructions 524 (e.g., software) embodying or utilized by any of the methodologies or functions described herein. The instructions 524 may also reside, completely or at least partially, within the main memory 504, the static memory 506, or within the processor 502 during execution thereof by the computer system 500, with the main memory 504, the static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database or associated caches and servers) that store the instructions 524. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excludes transitory signals.

The instructions 524 may be transmitted or received over a communications network 526 using a transmission medium via the network interface device 520 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
inputting a data file associated with an application into a generative artificial intelligence agent (genAI agent);
in response to the inputting, executing the genAI agent, wherein executing the genAI agent includes:
identifying a problem with the application;
determining a user identifier for addressing the problem;
determining a solution to the problem;
generating an action data structure; and
based on the action data structure, issuing an application programming interface (API) call to an issue tracking system to create a new issue ticket, the API call identifying the problem, the solution, and the user identifier;
receiving feedback from the user identifier, the feedback rating the solution; and
updating the genAI agent based on the feedback.

2. The method of claim 1, wherein generating an action data structure includes:
generating a structured output that includes a create new issue action identifier, the user identifier, the solution, and the problem.

3. The method of claim 1, wherein executing the genAI agent includes transmitting an alert to the user identifier.

4. The method of claim 1, wherein the data file is a merge request for code of the application.

5. The method of claim 4, wherein the problem is a conflict with another application.

6. The method of claim 1, wherein determining a solution to the problem includes:
suggesting a code change to the application.

7. The method of claim 1, wherein determining a potential solution to the problem includes:
suggesting delaying an update to another application.

8. The method of claim 1, wherein executing the genAI agent includes:
initiating automated testing for the application.

9. The method of claim 1, wherein executing the genAI agent includes:
assigning a severity level to the problem.

10. A non-transitory computer-readable medium comprising instructions, which when executed by a processing unit, configure the processing unit to perform operations comprising:
inputting a data file associated with an application into a generative artificial intelligence agent (genAI agent);
in response to the inputting, executing the genAI agent, wherein executing the genAI agent includes:
identifying a problem with the application;
determining a user identifier for addressing the problem;
determining a solution to the problem;
generating an action data structure; and
based on the action data structure, issuing an application programming interface (API) call to an issue tracking system to create a new issue ticket, the API call identifying the problem, the solution, and the user identifier;
receiving feedback from the user identifier, the feedback rating the solution; and
updating the genAI agent based on the feedback.

11. The non-transitory computer-readable medium of claim 10, wherein generating an action data structure includes:
generating a structured output that includes a create new issue action identifier, the user identifier, the solution, and the problem.

12. The non-transitory computer-readable medium of claim 10, wherein executing the genAI agent includes transmitting an alert to the user identifier.

13. The non-transitory computer-readable medium of claim 10, wherein the data file is a merge request for code of the application.

14. The non-transitory computer-readable medium of claim 13, wherein the problem is a conflict with another application.

15. The non-transitory computer-readable medium of claim 10, wherein determining a solution to the problem includes:
suggesting a code change to the application.

16. The non-transitory computer-readable medium of claim 10, wherein determining a potential solution to the problem includes:
suggesting delaying an update to another application.

17. The non-transitory computer-readable medium of claim 10, wherein executing the genAI agent includes:
initiating automated testing for the application.

18. The non-transitory computer-readable medium of claim 10, wherein executing the genAI agent includes:
assigning a severity level to the problem.

19. A system comprising:
a processing unit; and
a storage device comprising instructions, which when executed by the processing unit, configure the processing unit to perform operations comprising:
inputting a data file associated with an application into a generative artificial intelligence agent (genAI agent);
in response to the inputting, executing the genAI agent, wherein executing the genAI agent includes:
identifying a problem with the application;
determining a user identifier for addressing the problem;
determining a solution to the problem;
generating an action data structure; and
based on the action data structure, issuing an application programming interface (API) call to an issue tracking system to create a new issue ticket, the API call identifying the problem, the solution, and the user identifier;
receiving feedback from the user identifier, the feedback rating the solution; and
updating the genAI agent based on the feedback.

20. The system of claim 19, wherein generating an action data structure includes:
generating a structured output that includes a create new issue action identifier, the user identifier, the solution, and the problem.
